(19) United States
(12) Patent Application Publication
(10) Pub. No.: US 2007/0059546 A1
(43) Pub. Date: Mar. 15, 2007

(54) One solution-type thermosetting compositions for color filter protective films and color filters using the same

(75) Inventors: O Bum Kwon, Seoul (KR); Won Bum Jang, Seoul (KR); Sun Yul Lee, Kyoungki-do (KR)

Correspondence Address: Dolores W. Herman;Myers Bigel Sibley & Sajovec, P.A., P.O. Box 37428, Raleigh, NC, 27627, US

(73) Assignee: Cheil Industries, Inc.

(21) Appl. No.: 11/339,976

(22) Filed: Jan. 26, 2006

(30) Foreign Application Priority Data
Sep. 15, 2005 (KR) 2005-86191

(51) Int. Cl. B32B 27/30; C08F 220/26

(52) U.S. Cl. 428/523; 428/1.1; 526/317.1; 526/318.41; 526/329.6

(57) ABSTRACT

In some embodiments of the present invention, thermosetting one solution-type compositions for protective films for color filters may include:

(i) a self-curable copolymer including a) a repeating unit of Formula I in an amount in a range of about 5 to about 45 mol %, wherein R₁ may be hydrogen or alkyl; and b) one or more of the repeating units of Formulae II, III and IV, wherein each of the repeating units of Formula II, III and IV, if present, may independently be present in an amount in a range of about 20 to about 85 mol %, wherein R₂, R₃ and R₄ may each independently be hydrogen or alkyl, and p is a positive integer; and (ii) an organic solvent. 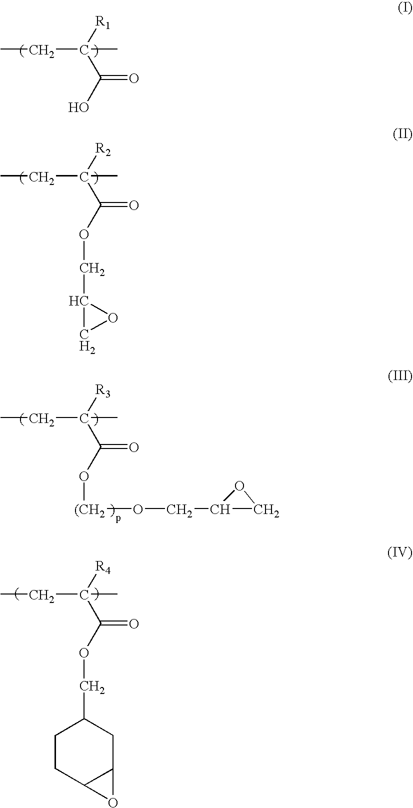 In some embodiments of the present invention, a color filter including a protective film formed from a composition according to an embodiment of the invention is provided. Further, in some embodiments of the present invention, a liquid crystal display including a color filter according to an embodiment of the invention is provided.

### CROSS-REFERENCE TO RELATED APPLICATION

This application claims priority under 35 U.S.C. § 119 from Korean Patent Application No. 10-2005-0086191, filed on Sep. 15, 2005, in the Korean Intellectual Property Office, the disclosure of which is incorporated by reference herein as if set forth in its entirety.

### FIELD OF THE INVENTION

The present invention relates to one solution-type compositions for protective films for color filters. Further, the invention relates to color filters including a protective film formed from a one solution-type composition, and to liquid crystal displays including such color filters.

### BACKGROUND OF THE INVENTION

In general, protective films are formed on the surface of color filters in liquid crystal displays (LCDs) for the purpose of planarizing and protecting the color filters. Ideally, such surface-protective films should have the desirable optical transparency and also possess sufficient film strength. In addition, such surface-protective films should have sufficient heat resistance to withstand subsequent processes for forming transparent conductive films on the protective films. Further, in some LCDs, such as vertical-alignment LCDs, it is also desirable that the surface-protective films possess sufficient acid resistance to withstand etching and sufficient base resistance to withstand resist peeling.

Materials and methods for forming protective films for color filters are known in the art. For example, Japanese Patent Laid-Open No. Hei 1-134306 describes the use of glycidyl methacrylate as a main component in a protective film, Japanese Patent Laid-Open No. Sho 62-163016 describes the use of a polyimide as a main component in a protective film and Japanese Patent Laid-Open No. Sho 63-131103 describes the use of a mixture of a melamine resin and an epoxy resin as a main component in a protective film.

Epoxy resins have been shown to have desirable properties in terms of adhesive strength and resistance to heat, chemicals and water. For example, Japanese Patent Laid-Open No. Hei 08-050289 describes a curable resin composition including a glycidyl methacrylate polymer and a phenolic curing agent. Japanese Patent Laid Open No. Hei 08-201617 describes a resin composition including an epoxy resin, a curing agent, and an organic solvent, wherein the curing agent is the reaction product of a styrene-maleic anhydride copolymer and an amine.

Epoxy resins may react rapidly with curing agents. Thus, when epoxy resins are mixed with curing agents in so-called “two solution-type compositions,” they are generally mixed immediately before use. These two solution-type compositions may be difficult to handle and may be unsuitable for industrial scale use. However, epoxy resins have been generally known in the art to be unsuitable for use in one solution-type compositions.

Other two solution-type compositions have been modified to improve storage stability. For example, Japanese Patent Laid-Open No. 2001-091732 describes a technique for improving storage stability by protecting a polyfunctional carboxylic compound with a vinyl ether. However, the protection of the polyfunctional carboxylic acid may require a complicated procedure. Further, the vinyl ether may be harmful to humans, and so the industrial applicability of this procedure is uncertain.

Thus, it would be desirable to prepare one solution-type compositions that provide the desirable transparency, film strength, heat resistance, acid resistance and base resistance.

### SUMMARY OF THE INVENTION

In some embodiments of the present invention, thermosetting one solution-type compositions for protective films for color filters may include:

(i) a self-curable copolymer including
a) a repeating unit of Formula I in an amount in a range of about 5 to about 45 mol %, wherein R₁ may be hydrogen or alkyl; and 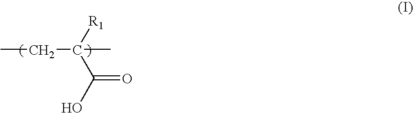
b) one or more of the repeating units of Formulae II, III and IV, wherein each of the repeating units of Formula II, III and IV, if present, may independently be present in an amount in a range of about 20 to about 85 mol %, wherein R₂, R₃ and R₄ may each independently be hydrogen or alkyl, and p is a positive integer; and

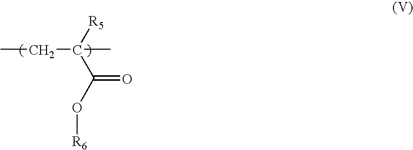

(ii) an organic solvent.

In some embodiments of the present invention, the self-curable copolymer of the thermosetting one solution-type composition further includes a repeating unit of Formula V, wherein R₅ may be hydrogen or alkyl, and R₆ may be cycloalkyl, adamantyl, norbornyl or tetrahydrocyclopentadienyl.

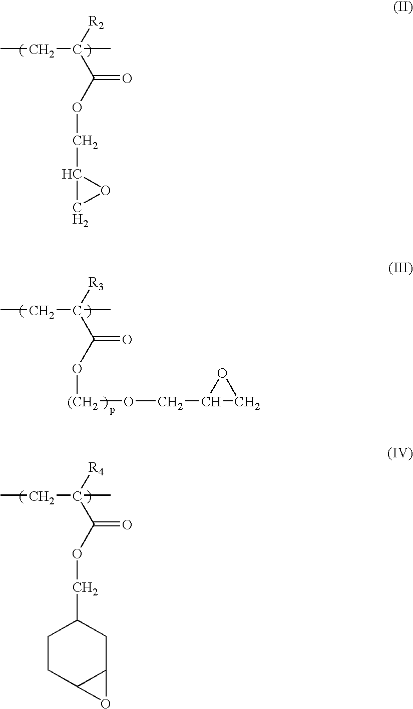

In some embodiments of the present invention, the self-curable copolymer of the thermosetting one solution-type composition further includes one or more of the following repeating units: acrylates, methacrylates, acrylamides, styrenes, N-vinylpyrrolidone, N-vinylformamide, N-vinylamide or N-vinylimidazole.

In some embodiments of the present invention, a color filter including a protective film formed from a composition according to an embodiment of the invention is provided.

Further, in some embodiments of the present invention, a liquid crystal display including a color filter according to an embodiment of the invention is provided.

### DETAILED DESCRIPTION OF EMBODIMENTS OF THE INVENTION

The invention is described more fully hereinafter. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element or layer is referred to as being “on,” another element or layer, it can be directly on, connected to, or coupled to the other element or layer, or intervening elements or layers may be present. In contrast, when an element is referred to as being “directly on,” “directly connected to,” or “directly coupled to” another element or layer, there are no intervening elements or layers present. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein:

The term “alkyl” refers to a monovalent, straight, branched or cyclic hydrocarbon (“cycloalkyl”) radical having from 1 to 15 carbon atoms. In some embodiments, the alkyl may be a “lower alkyl,” wherein the alkyl group has 1 to 4 carbons. For example, lower alkyl may include methyl, ethyl, propyl, isopropyl, butyl, iso-butyl and the like. The term C_{X} alkyl refers to an alkyl with x carbon atom(s), and thus, the term C₁-C₃ alkyl refers to any alkyl having from 1 to 3 carbon atoms. Exemplary cycloalkyl include C₅-C₁₃ cycloalkyl.

The term “adamantyl” refers to any radical formed by extracting a hydrogen atom from adamantane. 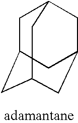
The adamantyl groups may be unsubstituted or substituted, for example, with alkyl groups, as defined herein. Exemplary adamantyl groups include 2-adamantyl and 2-alkyl-2-adamantyl.

The term “norbornyl” refers to any radical formed by extracting a hydrogen atom from norbonane. 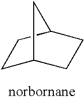
The norbornyl groups may be unsubstituted or substituted, for example, with alkyl groups, as defined herein. Exemplary norbornyl groups include 1,7,7-trimethyl-2-norbornyl and 1,7,7-trimethyl-3-norbornyl.

The term “tetrahydrocyclopentadienyl” refers to any radical formed by extracting a hydrogen atom from tetrahydrocyclopentadiene.

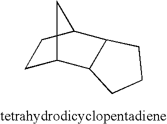

The tetrahydocyclopentadienyl groups may be unsubstituted or substituted, for example, with alkyl groups, as defined herein.

The term “self-curable copolymer” is meant to refer to a copolymer that may crosslink without the addition of any other polymer or reagent. However, the crosslinking of a self-curable copolymer may be facilitated by the addition of catalysts, couplers, or other reagents known to one of skill in the art. The crosslinking may also be facilitated by thermal or photochemical treatment, or any other technique known to one of skill in the art.

In some embodiments of the present invention, thermosetting one solution-type compositions for protective films for color filters may include:

(i) a self-curable copolymer including
a) a repeating unit of Formula I in an amount in a range of about 5 to about 45 mol %, wherein R₁ may be hydrogen or alkyl; and 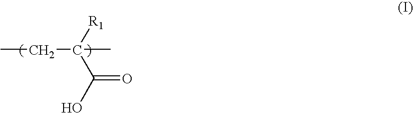
b) one or more of the repeating units of Formulae II, III and IV, wherein each of the repeating units of Formulae II, III and IV, if present, may independently be present in an amount in a range of about 20 to about 85 mol %, wherein R₂, R₃ and R₄ may each independently be hydrogen or alkyl, and p is a positive integer; and

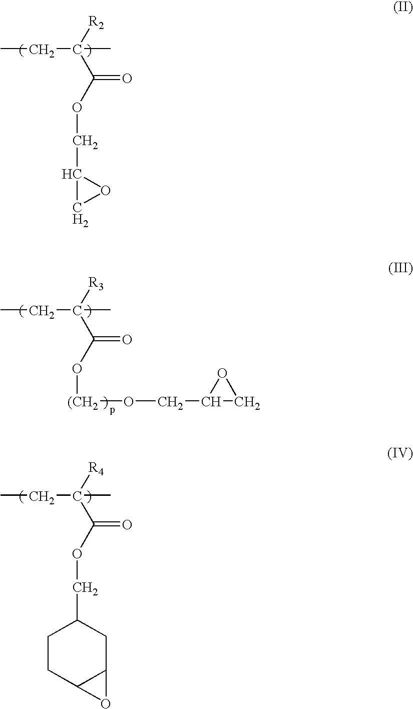

(ii) an organic solvent.

In some embodiments of the present invention, the self-curable copolymer of the thermosetting one solution-type composition further includes a repeating unit of Formula V, wherein R₅ may be hydrogen or alkyl, and R₆ may be cycloalkyl, adamantyl, norbornyl or tetrahydrocyclopentadienyl.

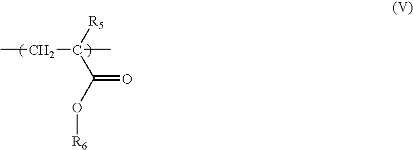

The addition of the repeating unit of Formula V may lead to an improvement in transparency and solubility in the organic solvent. The mole fraction of the repeating unit of Formula V may be in a range of about 10 to about 30 mol %, and may be adjusted to achieve optimal adhesive strength, transparency, film strength, heat resistance, acid resistance, alkali resistance and long-term storage stability.

In some embodiments of the present invention, the self-curable copolymer of the thermosetting one solution-type composition further includes one or more of the following repeating units: acrylates, including methyl acrylate, ethyl acrylate, propyl acrylate, isopropyl acrylate, butyl acrylate, benzyl acrylate, hydroxylethyl acrylate and hydroxylpropyl acrylate; methacrylates, including methyl methacrylate, ethyl methacrylate, propyl methacrylate, isopropyl methacrylate, butyl methacrylate, benzyl methacrylate, hydroxylethyl methacrylate and hydroxylpropyl methacrylate; acrylamides, including N-methylacrylamide, N-ethylacrylamide, N-isopropylacrylamide, N-methylolacrylamide, N-methylmethacrylamide, N-ethylmethacrylamide, N-isopropylmethacrylamide, N-methylolmethacrylamide, N,N-dimethylacrylamide, N,N-diethylacrylamide, N,N-dimethylmethacrylamide and N,N-diethylmethacrylamide; styrenes, including styrene, α-methylstyrene and hydroxystyrene; N-vinylpyrrolidone; N-vinylformamide; N-vinylamide; and N-vinylimidazole.

The self-curable copolymer may include the repeating units in a random, alternating, block or graft copolymer fashion. Thus, for example, if the self-curable copolymer includes the repeating unit of Formula I and the repeating unit of Formula II, then the repeating units of Formula I and II may be present in any order, including as random, alternating, block or graft copolymers. As another example, if the self-curable copolymer includes the repeating units of Formulae I, II, III, IV and V, and further includes an acrylate monomer, the repeating units of Formulae I, II, III, IV, V and the acrylate monomer may be present in any order, including random, alternating, block or graft copolymers.

In some embodiments, R₁, R₂, R₃, R₄ and R₅ may each independently be hydrogen or C₁-C₃ alkyl, and p may be a positive integer between 1 and 9.

Further, in some embodiments, R₆ may be C₅-C₁₃ cycloalkyl, 1,7,7-trimethyl-2-norbornyl, 1,7,7-trimethyl-3-norbornyl 2-adamantyl, 2-alkyl-2-adamantyl or tetrahydrocyclopentadienyl.

Further, in some embodiments of the present invention, the repeating units of Formulae II, III and IV may, in total, be present in an amount in a range of about 20 to about 85 mol %. In other words, the sum of the mole percents of the repeating units of Formulae II, III and IV may be within a range of about 20 to about 85 mol %.

In some embodiments of the present invention, the self-curable copolymer may have a weight average molecular weight in a range of about 3,000 to about 1,000,000 g/mol. If the molecular weight of the self-curable copolymer is too low, the copolymer may be difficult to cure. However, if the molecular weight of the self-curable copolymer is too high, the copolymer may not have the desired solubility properties. One of skill in the art will know how to select a specific molecular weight for use in a particular composition.

There is no restriction on the kind of the organic solvent that may be used in compositions according to embodiments of the invention, but the organic solvent should be able to dissolve the self-curable copolymer present in the composition. In some embodiments, the organic solvent may include ethylene glycols, including ethylene glycol and diethylene glycol; glycol ethers, including ethylene glycol monomethyl ether, diethylene glycol monomethyl ether, ethylene glycol diethyl ether, and diethylene glycol dimethyl ether; glycol ether acetates, including ethylene glycol monoethyl ether acetate, diethylene glycol monoethyl ether acetate, and diethylene glycol monobutyl ether acetate; propylene glycols; propylene glycol ethers, including propylene glycol monomethyl ether, propylene glycol monoethyl ether, propylene glycol monopropyl ether, propylene monobutyl ether, propylene glycol dimethyl ether, dipropylene glycol dimethyl ether, propylene glycol diethyl ether, and dipropylene glycol diethyl ether; propylene glycol ether acetates, including propylene glycol monomethyl ether acetate and dipropylene glycol monoethyl ether acetate; amides, including N-methylpyrrolidone, dimethylformamide, and dimethylacetamide; ketones, including methyl ethyl ketone (MEK), methyl isobutyl ketone (MIBK), and cyclohexanone; petroleum solvents, including toluene, xylene, and solvent naphtha; esters, including ethylacetate, butylacetate, and ethyl lactate; or any mixtures thereof.

The self-curable copolymers according to embodiments of the invention may be synthesized by any process known in the art. In some embodiments, the self-curable copolymer is synthesized using a radical polymerization initiator, and in some embodiments, the copolymer is synthesized in the same organic solvent that is used in a thermosetting one solution-type composition according to an embodiment of the present invention.

In some embodiments, the amount of the organic solvent used during the polymerization may be controlled so that the self-curable copolymer is present in an amount of about 5 to about 50% by weight, preferably about 10 to about 30% by weight, relative to the weight of the solution of the self-curable copolymer in the organic solvent. If the concentration of the self-curable copolymer in the solution is less than about 5% by weight, the polymerization rate may be low and thus some of the monomer may remain unreacted. However, if the concentration of the self-curable copolymer in the solution exceeds about 50% by weight, the solution may become highly viscous, making it difficult to handle and difficult to control the reaction rate. The selection of the appropriate concentration used to yield the desired properties is within the knowledge of one of ordinary skill in the art.

Suitable polymerization initiators that may be used in the synthesis of the self-curable copolymer include all known initiators, e.g., thermal polymerization initiators, photopolymerization initiators and redox initiators. In some embodiments, peroxide-based or azo-based radical polymerization initiators are preferred.

Exemplary peroxide-based polymerization initiators may include methyl ethyl ketone peroxide, cyclohexanone peroxide, methyl cyclohexanone peroxide, acetyl acetone peroxide, 1,1-bis(tert-butylperoxy)-3,3,5-trimethylcyclohexane, 1,1-bis(tert-butylperoxy)cyclohexane, 1,1-bis(tert-hexylperoxy)-3,3,5-trimethylcyclohexane, 1,1-bis(tert-hexylperoxy)cyclohexane, 1,1-bis(tert-butylperoxy)cyclododecane, isobutyl peroxide, lauroyl peroxide, succinic acid peroxide, 3,5,5-trimethylhexanoyl peroxide, benzoyl peroxide, octanoyl peroxide, stearoyl peroxide, diisopropyl peroxydicarbonate, di-n-propyl peroxydicarbonate, di-2-ethylhexyl peroxydicarbonate, di-2-ethoxyethyl peroxydicarbonate, di-2-methoxybutyl peroxydicarbonate, bis-(4-tert-butylcyclohexyl)peroxydicarbonate, (α,α-bis-neodecanoylperoxy)diisopropylbenzene, peroxy cumyl neodecanoic acid ester, peroxy octyl neodecanoic acid ester, peroxy hexyl neodecanoic acid ester, peroxy tert-butyl neodecanoic acid ester, peroxy tert-hexyl pivalic acid ester, peroxy tert-butyl pivalic acid ester, 2,5-dimethyl-2,5-bis(2-ethylhexanoylperoxy)hexane, 1,1,3,3-tetramethylbutylperoxy-2-ethylhexanoate, peroxy-2-ethyl-tert-hexyl hexanoic acid ester, peroxy-2-ethyl-tert-butyl hexanoic acid ester, peroxy-2-ethyl-tert-butyl hexanoic acid ester, peroxy-3-methyl-tert-butyl propionic acid ester, peroxy-tert-butyl lauric acid ester, tert-butylperoxy-3,5,5-trimethylhexanoate, tert-hexyl peroxyisopropyl monocarbonate, tert-butylperoxy isopropyl carbonate, 2,5-dimethyl-2,5-bis(benzoylperoxy)hexane, tert-butyl peracetic acid ester, tert-hexyl perbenzoic acid ester, and tert-butyl perbenzoic acid ester. Combinations of the peroxide-based polymerization initiators with reductants may also be used as redox initiators.

Exemplary azo-based polymerization initiators may include 1,1-azobis(cyclohexane-1-carbonitrile), 2,2′-azobis(2-methyl-butyronitrile), 2,2′-azobisbutyronitrile, 2,2′-azobis(2,4-dimethyl-valeronitrile), 2,2′-azobis(2,4-dimethyl-4-methoxyvaleronitrile), 2,2′-azobis(2-amidino-propane) hydrochloride, 2,2′-azobis[2-(5-methyl-2-imidazolin-2-yl)propane]hydrochloride, 2,2′-azobis[2-(2-imidazolin-2-yl)propane]hydrochloride, 2,2′-azobis[2-(5-methyl-2-imidazolin-2-yl)propane], 2,2′-azobis[2-methyl-N-(1,1-bis(2-hydroxymethyl)-2-hydroxyethyl]propionic amide, 2,2′-azobis[2-methyl-N-(2-hydroxyethyl)propionic amide], 2,2′-azobis(2-methyl-propionic amide) dihydrate, 4,4′-azobis(4-cyano-valeic acid), 2,2′-azobis(2-hydroxymethylpropionitrile), 2,2′-azobis(2-methylpropionic acid)dimethyl ester (dimethyl-2,2′-azobis(2-methylpropionate)) (V-601, Wako Pure Chemical Industries Ltd.), and cyano-2-propylazoformamide.

In some embodiments of the present invention, a molecular weight-controlling agent, such as a chain-transfer agent, a chain-terminating agent or a polymerization promoter, may also be added during the preparation of the self-curable copolymer in order to achieve the preferred molecular weight range. Exemplary molecular weight-controlling agents may include mercaptopropionic acid, mercaptopropionic acid ester, thioglycol, thioglycerin, dodecylmercaptan and α-methylstyrene dimers.

In some embodiments, additional solvents may be added during the preparation of the self-curable copolymer. Further, additional solvents may be present in the thermosetting one solution-type compositions according embodiments of the invention. These additional solvents may increase the solubility of the constituent components and/or help to control the leveling properties and drying rate after polymerization.

In some embodiments, the self-curable copolymer may be extracted into a solid form for the purpose of purification, storage and/or solvent change. The extraction of the self-curable copolymer may be performed by spray drying, film drying, dropping into poor solvents, re-dipping, and the like, but is not limited thereto. In some embodiments, a self-curable copolymer in a solid form may be used to constitute a thermosetting one solution-type composition according to an embodiment of the present invention.

Additional polymers may also be added to the thermosetting one solution-type compositions. The additional polymers may improve the etching resistance and/or alkali resistance and control the fluidity of the composition. The polymers may include, for example, epoxy-based resins, such as bisphenol-A-based epoxy, bisphenol-F-based epoxy, phenol novolac-based epoxy, cresol novolac-based epoxy and substituted epoxy resins; polyacrylate-based resins; polymethacrylate resins; polyamide resins; polyester resins; polyimide resins and silicone-based resins. In some embodiments, the amount of the additional polymers added is about 50 parts by weight or less, based on 100 parts by weight of the self-curable copolymer.

Since a thermal crosslinking reaction may occur between at least one repeating unit selected from the repeating units represented by Formulae II, III and IV and the repeating unit of Formula I, the self-curing copolymer used in a thermosetting one solution-type composition according to an embodiment of the present invention may exhibit thermosetting properties.

A thermosetting reaction catalyst may be optionally be added to the thermosetting one solution-type composition of the present invention. Examples of thermosetting reaction catalysts include amine compounds, phosphorus compounds, boron compounds, antimony compounds, carboxylic acid compounds and organic sulfonic acid compounds. In some embodiments, the thermosetting reaction catalyst is present in the composition in an amount of about 10 parts by weight or less, based on 100 parts by weight of the self-curable polymer. This lower concentration of reaction catalyst may be desirable from the standpoint of storage stability.

If required, the thermosetting one solution-type composition of the present invention may be further blended with other known agents, e.g., antioxidants, infrared stabilizers, plasticizers, leveling agents, surfactants, coupling agents and fillers.

A thermosetting one solution-type composition according to an embodiment of the present invention may be applied to a substrate by any technique known in the art, e.g., screen printing, curtain coating, blade coating, spin coating, spray coating, dip coating, flow coating, roll coating, slit coating and the like, to form a protective film for a color filter. In some embodiments, the film thus formed has a thickness in a range of about 0.5 to about 5 μm, and preferably about 0.7 to about 2.5 μm, after subsequent drying. If the film has a thickness of less than 0.5 μm, sufficient planarity of step height may not be attained. However, if the film has a thickness exceeding 5 μm, the transmittance may be decreased, considerable drying and curing time may be required, and productivity may be reduced.

The substrate coated with a thermosetting one solution-type composition of the present invention may be subjected to drying and heat-curing to evaporate the solvent and to facilitate crosslinking of the composition. The drying and the heat-curing processes may be carried out simultaneously or individually. Since rapid heating may cause the formation of foams and cracks, in some embodiments, it may be preferable to carry out the drying and heat-curing processes individually.

Apparatuses for the drying process are not limited, and include, for example, hot-air dryers, far-infrared dryers, hot plates and the like. In some embodiments, the drying process is carried out at a temperature in a range of about 50° C. to about 150° C. The drying time may vary depending on the capacity of a dryer employed, airflow, temperature and film thickness. In some embodiments, the drying time is in a range of about 1 to about 10 minutes.

Apparatuses for the heat-curing process are also not limited, and include, for example, hot-air ovens, far-infrared ovens, hot plates and the like. In some embodiments, the heat-curing process is carried out at a temperature in a range of about 150° C. to about 250° C. Below 150° C., curing may not be satisfactory. Meanwhile, above 250° C., depolymerization and carbonization of the polymers may occur, which may deteriorate the performance of the final film.

In some embodiments of the present invention, a color filter including a protective film formed from a composition according to an embodiment of the invention is provided. In some embodiments, the protective film may have a thickness in a range of about 0.5 to about 5 μm.

Further, in some embodiments of the present invention, a liquid crystal display including a color filter according to an embodiment of the invention is provided.

### EXAMPLES

The present invention will now be described in more detail with reference to the following examples and comparative examples. However, these examples are given for the purpose of illustration and are not to be construed as limiting the scope of the invention.

### Example 1

Propylene glycol monomethyl ether acetate (297 g, PGMEA) was added to a 500 ml flask equipped with a reflux condenser and an agitator, and the reaction temperature was increased to 80° C. while the PGMEA was stirred. At this temperature, a mixture of 56 g of methacrylic acid, 78 g of glycidyl methacrylate and 6.8 g of dimethyl-2,2′-azobis(2-methylpropionate) (V-601, Wako Pure Chemical Industries Ltd.) was added dropwise to the flask for approximately 1 to 1.5 hours. The resulting mixture was allowed to react for approximately 4 to 5 hours, while stirring and maintaining the reaction temperature at 80° C., to obtain a transparent polymeric solution (A). Gel permeation chromatography (GPC) of the solution indicated a weight average molecular weight of 30,000 g/mol, based on a polystyrene standard.

To 40 g of the polymeric solution (A) were added 3.5 g of an epoxy resin (EP-152, JER), 1.4 g of a silane coupling agent (S-510, Chisso), 0.12 g of a surfactant (F-475, DIC) and 31 g of PGMEA. The mixture was sufficiently dissolved by stirring, and then filtered to prepare the desired thermosetting one solution-type composition (F) for use as a protective film for a color filter.

The thermosetting one solution-type composition (F) was applied to a glass substrate, (thickness: 0.7 mm, #1737, Corning) and a dummy color filter onto which an RGB pattern was formed, using a spin coater, dried in a dryer at 80° C. for 3 minutes and cured at 230° C. for 50 minutes to produce a 1.5 μm thick transparent protective film and a color filter, respectively.

### Example 2

PGMEA (290 g) was added to a 500 ml flask equipped with a reflux condenser and an agitator, and the reaction temperature was increased to 80° C. while the PGMEA was stirred. At this temperature, a mixture of 14 g of methacrylic acid, 34 g of glycidyl methacrylate, 78 g of dicyclopentanyl methacrylate (FA-513M, Hitachi Chemical Co., Ltd.) and 6.8 g of dimethyl-2,2′-azobis(2-methylpropionate) (V-601, Wako Pure Chemical Industries Ltd.) was added dropwise to the flask for approximately 1 to 1.5 hours. The resulting mixture was allowed to react for approximately 4 to 5 hours, while stirring and maintaining the reaction temperature at 80° C., to obtain a transparent polymeric solution (B). GPC of the solution indicated a weight average molecular weight of 32,000 g/mol, based on a polystyrene standard.

A thermosetting one solution-type composition (G) for a protective film for a color filter was prepared in the same manner as in Example 1, except that 40 g of the polymeric solution (B) was used instead of the polymeric solution (A) prepared in Example 1.

A 1.5 μm thick transparent protective film and a color filter were produced using the thermosetting one solution-type composition (G) in accordance with the procedure of Example 1.

### Example 3

PGMEA (290 g) was added to a 500 ml flask equipped with a reflux condenser and an agitator, and the reaction temperature was increased to 80° C. while the PGMEA was stirred. At this temperature, a mixture of 28 g of methacrylic acid, 18 g of glycidyl methacrylate, 60 g of styrene, and 6.8 g of dimethyl-2,2′-azobis(2-methylpropionate) (V-601, Wako Pure Chemical Industries Ltd.) was added dropwise to the flask for approximately 1 to 1.5 hours. The resulting mixture was allowed to react for approximately 4 to 5 hours, while stirring and maintaining the reaction temperature at 80° C., to obtain a transparent polymeric solution (C). GPC of the solution indicated a weight average molecular weight of 23,000 g/mol, based on a polystyrene standard.

A thermosetting one solution-type composition (H) for a protective film for a color filter was prepared in the same manner as in Example 1, except that 40 g of the polymeric solution (C) was used instead of the polymeric solution (A) prepared in Example 1.

A 1.5 μm thick transparent protective film and a color filter were produced using the thermosetting one solution-type composition (H) instead of the thermosetting one solution-type composition (F), in accordance with the procedure of Example 1.

### Example 4

PGMEA (290 g) was added to a 500 ml flask equipped with a reflux condenser and an agitator, and the reaction temperature was increased to 80° C. while the PGMEA was stirred. At this temperature, a mixture of 28 g of methacrylic acid, 18 g of glycidyl methacrylate, 58 g of cyclohexane methacrylate (Aldrich) and 6.8 g of dimethyl-2,2′-azobis(2-methylpropionate) (V-601, Wako Pure Chemical Industries Ltd.) was added dropwise to the flask for approximately 1 to 1.5 hours. The resulting mixture was allowed to react for approximately 4 to 5 hours, while stirring and maintaining the reaction temperature at 80° C., to obtain a transparent polymeric solution (D). GPC of the solution indicated a weight average molecular weight of 25,000 g/mol, based on a polystyrene standard.

A thermosetting one solution-type composition (I) for a protective film for a color filter was prepared in the same manner as in Example 1, except that 40 g of the polymeric solution (D) was used instead of the polymeric solution (A) prepared in Example 1.

A 1.5 μm thick transparent protective film and a color filter were produced using the thermosetting one solution-type composition (I) instead of the thermosetting one solution-type composition (F), in accordance with the procedure of Example 1.

### Comparative Example 1

PGMEA (390 g) was added to a 500 ml flask equipped with a reflux condenser and an agitator, and the reaction temperature was increased to 80° C. while the PGMEA was stirred. At this temperature, a mixture of 79 g of glycidyl methacrylate, 30 g of dicyclopentanyl methacrylate (FA-513M, Hitachi Chemical Co., Ltd.), 12 g of styrene and 8.5 g of dimethyl-2,2′-azobis(2-methylpropionate) (V-601, Wako Pure Chemical Industries Ltd.) was added dropwise to the flask for approximately 1 to 1.5 hours. The resulting mixture was allowed to react for 3 hours, with stirring, while maintaining the reaction temperature at 80° C. to obtain a transparent polymeric solution (E). GPC of the solution indicated a weight average molecular weight of 17,000 g/mol, based on a polystyrene standard.

To 40 g of the polymeric solution (E) were added 3.5 g of an epoxy resin (EP-152, JER), 1.4 g of a silane coupling agent (S-510, Chisso), 3.1 g of trimellitic anhydride (Aldrich), 0.12 g of a surfactant (F-475, DIC), and 31 g of propylene glycol monomethyl ether acetate. The mixture was sufficiently dissolved by stirring, and filtered to prepare a desired thermosetting one solution-type composition (J) for a protective film of a color filter.

A 1.5 μm thick transparent protective film and a color filter were produced using the thermosetting one solution-type composition (J) instead of the thermosetting one solution-type composition (F), in accordance with the procedure of Example 1.

Evaluation of Physical Properties

The planarity, adhesiveness, film strength, heat resistance and UV stability of the protective films and color filters produced in Examples 1 to 4 and Comparative Example 1 were evaluated in accordance with the following procedures. The storage stability of the thermosetting compositions prepared in Examples 1 to 4 and Comparative Example 1 was also evaluated. The results are shown in Table 1 below.

i) Planarity

First, the difference in height between central red and green pixels (step height between pixels) of a dummy color filter was measured. Then, the difference in height between central red and green pixels of a color filter coated with each of the protective films produced in Examples 1 to 4 and Comparative Example 1 was measured. The ratio R of the step height (d₁) before the formation of the protective film to the step height (d₂) after the formation of the protective film was calculated according to Equation (1) below:
R=d₂/d₁ (1)

The planarity of the protective film compositions prepared in Examples 1 to 4 and Comparative Example 1 was classified into five grades based on the following criteria:

(1) R>0.4;

(2) 0.4≧R≧0.3;

(3) 0.3≧R≧0.2;

(4) 0.2≧R≧0.1;

(5) R<0.1.

The higher the grade, the more planar the surface.

ii) Adhesiveness and Chemical Resistance

After one hundred cross-cuts were scribed in the shape of check scales on the protective films produced in Examples 1 to 4 and Comparative Example 1, a peeling test (cross-cut test) was conducted using a cellophane tape. The peeling state of the cross-cuts was checked by visual inspection to evaluate the adhesiveness.

Further, after the protective films were dipped in N-methyl-2-pyrrolidone (NMP), a 10% aqueous potassium hydroxide solution and an etchant solution (CYANTEK CORPORATION LCE-12K) at 40° C. for 30 minutes, the procedure of the above adhesiveness test was repeated to evaluate the chemical resistance. The peeling state of the cross-cuts was observed. When no cross-cuts were peeled after the dipping, the chemical resistance against the solutions was judged as “passed.” When at least one cross-cut was peeled after the dipping, the chemical resistance against the solutions was judged as “failed.”

iii) Film Strength

After the transparent protective films produced in Examples 1 to 4 and Comparative Example 1 were scratched using six kinds (1H˜6H) of pencils (Statdler), damage to the films was observed. The strength of the films was classified into six grades (1H ˜6H) according to the degree of the damage.

iv) Storage Stability

First, the viscosity of the thermosetting compositions prepared in Examples 1 to 4 and Comparative Example 1 was measured. While each of the compositions was placed in a 10 ml vial in an incubator at 40° C., the viscosity was measured once every three days for twelve days. The number of periods when the increase in viscosity exceeded 10% was expressed as 0, 3, 6, 9 or 12. 0 and 3 were evaluated to be “poor.”

v) Heat Resistance

First, the thickness of the transparent protective films produced in Examples 1 to 4 and Comparative Example 1 was measured. After each of the transparent protective films was put into an oven and left at 300° C. for 3 hours, the thickness of the film was measured. Decrease in the thickness of the transparent protective films before and after heating was compared. The heat resistance was judged to be “good” when the decrease in thickness was within 10%, and was judged to be “poor” when the decrease in thickness exceeded 10%.

vi) UV Stability

After one hundred cross-cuts were scribed in the shape of check scales on the protective films produced in Examples 1 to 4 and Comparative Example 1, a peeling test (cross-cut test) was conducted using a cellophane tape. The peeling state of the cross-cuts was checked by visual inspection to evaluate the adhesiveness. While the protective films were continuously irradiated with UV light of fixed intensity, the peeling test (cross-cut test) was repeated every three hours. The peeling state of the cross-cuts was observed (expressed as peeled area/total area (%)).

TABLE 1

| Example | | | Chemical | | Film | Storage | Heat |
|---|---|---|---|---|---|---|---|
| No. | Planarity | Adhesiveness | resistance* | Transmittance | strength | stability | resistance |
| Ex. 1 | 2 | 100/100 | Passed (Acid, | 99 | 3H | 6 | Good (8%) |
| | | | base, organic) | | | | |
| Ex. 2 | 4 | 100/100 | Passed (Acid, | 98 | 5H | 9 | Good (4%) |
| | | | base, organic) | | | | |
| Ex. 3 | 3 | 100/100 | Passed (Acid, | 99 | 5H | 9 | Good (5%) |
| | | | base, organic) | | | | |
| Ex. 4 | 4 | 100/100 | Passed (Acid, | 98 | 4H | 12 | Good (5%) |
| | | | base, organic) | | | | |
| Comp. | 2 | 100/100 | Failed (Base) | 98 | 4H | 3 (Poor) | Poor (13%) |
| Ex. 1 | | | | | | | |

*Before and after dipping in N-methyl-2-pyrrolidone (NMP, organic), a 10% aqueous potassium hydroxide solution (base) and an etchant solution (acid), 40° C., 30 min.

TABLE 2

| | 3 hours | 6 hours | 9 hours | 12 hours |
|---|---|---|---|---|
| | after UV | after UV | after UV | after UV |
| Example No. | irradiation | irradiation | irradiation | irradiation |
| Example 1 | 100/100 | 100/100 | 100/100 | 99/100 |
| Example 2 | 100/100 | 100/100 | 98/100 | 97/100 |
| Example 3 | 100/100 | 100/100 | 100/100 | 100/100 |
| Example 4 | 100/100 | 99/100 | 97/100 | 95/100 |
| Comparative | 98/100 | 82/100 | 51/100 | 12/100 |
| Example 1 | | | | |

As can be seen from the data shown in Table 1, the protective films for color filters produced from the thermosetting one solution-type compositions according to embodiments of the present invention may exhibit superior planarity, adhesiveness, transmittance, film strength and heat resistance. In addition, the storage stability of the compositions may be maintained for a long period of time compared to a conventional thermosetting composition for a protective film for a color filter. Futher, as shown in Table 2, compositions according to embodiments of the present invention may have superior UV stability compared to conventional thermosetting compositions for protective films for color filters.

What is claimed is:

1. A thermosetting one solution-type composition for a protective film for a color filter, comprising:
(i) a self-curable copolymer comprising
a) a repeating unit of Formula I in an amount in a range of about 5 to about 45 mol %, wherein R₁ is hydrogen or alkyl; and 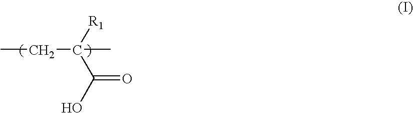
b) one or more of the repeating units of Formulae II, III and IV, wherein each of the repeating units of Formula II, III and IV, if present, is present in an amount in a range of about 20 to about 85 mol %, wherein R₂, R₃ and R₄ are each independently hydrogen or alkyl, and p is a positive integer; and 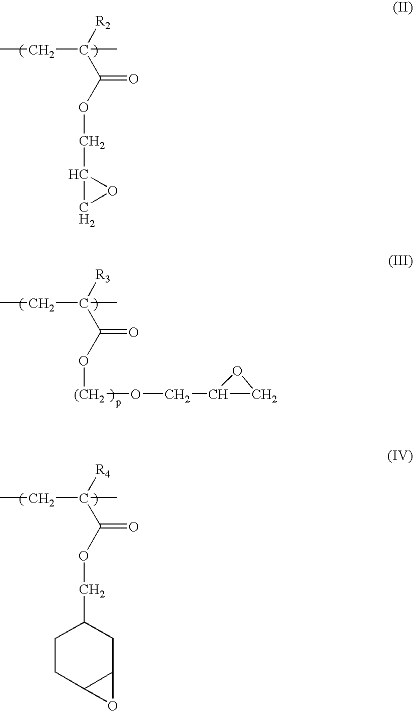
(ii) an organic solvent.

2. The composition of claim 1, wherein R₁, R₂, R₃ and R₄ are each independently hydrogen or C₁-C₃ alkyl, and p is a positive integer between 1 and 9.

3. The composition of claim 1, wherein the repeating units of Formulae II, III and IV are, in total, present in an amount in a range of about 20 to about 85 mol %.

4. The composition of claim 1, wherein the self-curable copolymer has a weight average molecular weight in a range of about 3,000 to about 1,000,000 g/mol.

5. The composition of claim 1, wherein the organic solvent is selected from the group consisting of ethylene glycols, glycol ethers, glycol ether acetates, propylene glycol ethers, propylene glycol ether acetates, amides, ketones, petroleum solvents, esters and any mixture thereof.

6. The composition of claim 1, further comprising at least one resin selected from the group consisting of epoxy-based resins, polyacrylate-based resins, polymethacrylate-based resins, polyamide resins, polyester resins, polyimide resins and silicone-based resins.

7. The composition of claim 1, further comprising at least one additive selected from the group consisting of antioxidants, infrared stabilizers, plasticizers, leveling agents, surfactants, coupling agents and fillers.

8. A thermosetting one solution-type composition for a protective film for a color filter, comprising:
(i) a self-curable copolymer comprising
a) a repeating unit of Formula I in an amount in a range of about 5 to about 45 mol %, wherein R₁ is hydrogen or alkyl; and 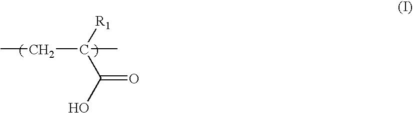
b) one or more of the repeating units of Formulae II, III and IV, wherein each of the repeating units of Formula II, III and IV, if present, is present in an amount in a range of about 20 to about 85 mol %, wherein R₂, R₃ and R₄ are each independently hydrogen or alkyl, and p is a positive integer; and 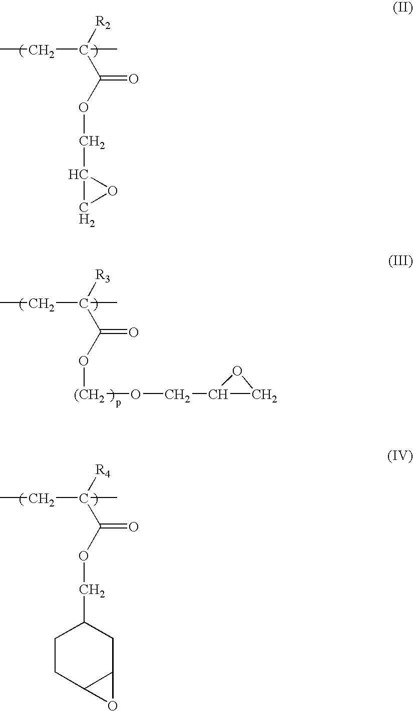
(c) one or more repeating units selected from the group consisting of acrylates, methacrylates, acrylamides, styrenes, N-vinylpyrrolidone, N-vinylformamide; N-vinylamide, and N-vinylimidazole; and
(ii) an organic solvent.

9. The composition of claim 8, wherein R₁, R₂, R₃ and R₄ are each independently hydrogen or C₁-C₃ alkyl, and p is a positive integer between 1 and 9.

10. The composition of claim 8, wherein the repeating units of Formulae II, III and IV are, in total, present in an amount in a range of 20 to 85 mol %.

11. The composition of claim 8, wherein the self-curable copolymer has a weight average molecular weight in a range of about 3,000 to about 1,000,000 g/mol.

12. The composition of claim 8, wherein the organic solvent is selected from the group consisting of ethylene glycols, glycol ethers, glycol ether acetates, propylene glycol ethers, propylene glycol ether acetates, amides, ketones, petroleum solvents, esters and any mixture thereof.

13. The composition of claim 8, further comprising at least one resin selected from the group consisting of epoxy-based resins, poly acrylate-based resins, polymethacrylate-based resins, polyamide resins, polyester resins, polyimide resins and silicone-based resins.

14. The composition of claim 8, further comprising at least one additive selected from the group consisting of antioxidants, infrared stabilizers, plasticizers, leveling agents, surfactants, coupling agents and fillers.

15. A thermosetting one solution-type composition for a protective film for a color filter, comprising:
(i) a self-curable copolymer comprising
a) a repeating unit of Formula I in an amount in a range of about 5 to about 45 mol %, wherein R₁ is hydrogen or alkyl; and 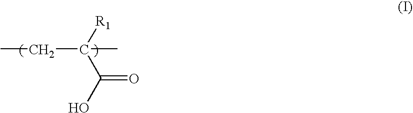
b) one or more of the repeating units of Formulae II, III and IV, wherein each of the repeating units of Formula II, III and IV, if present, is present in an amount in a range of about 20 to about 85 mol %, wherein R₂, R₃ and R₄ are each independently hydrogen or alkyl, and p is a positive integer; and 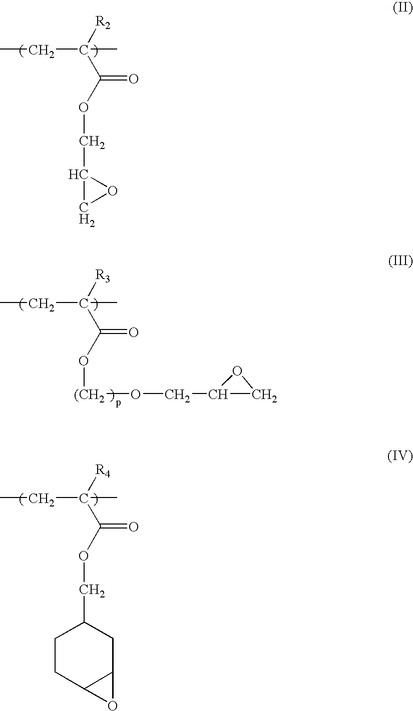
(c) a repeating unit of Formula V in an amount in a range of about 10 to about 30 mol %, wherein R₅ is hydrogen or alkyl, and R₆ is selected from the group consisting of cycloalkyl, adamantyl, norbornyl and tetrahydrocyclopentadienyl; and 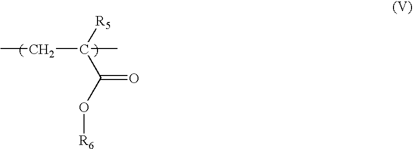
(ii) an organic solvent.

16. The composition of claim 15, wherein R₁, R₂, R₃, R₄ and R₅ are each independently hydrogen or C₁-C₃ alkyl, and p is a positive integer between 1 and 9.

17. The composition of claim 15, wherein R₆ is selected from the group consisting of C₅-C₁₃ cycloalkyl, 1,7,7-trimethyl-2-norbornyl, 1,7,7-trimethyl-3-norbornyl 2-adamantyl, 2-alkyl-2-adamantyl and tetrahydrocyclopentadienyl.

18. The composition of claim 15, wherein the repeating units of Formulae II, III and IV are, in total, present in an amount in a range of about 20 to about 85 mol %.

19. The composition of claim 15, wherein the self-curable copolymer has a weight average molecular weight in a range of about 3,000 to about 1,000,000 g/mol.

20. The composition of claim 15, wherein the organic solvent is selected from the group consisting of ethylene glycols, glycol ethers, glycol ether acetates, propylene glycol ethers, propylene glycol ether acetates, amides, ketones, petroleum solvents, esters and any mixture thereof.

21. The composition of claim 15, further comprising at least one resin selected from the group consisting of epoxy-based resins, polyacrylate-based resins, polymethacrylate-based resins, polyamide resins, polyester resins, polyimide resins and silicone-based resins.

22. The composition of claim 15, further comprising at least one additive selected from the group consisting of antioxidants, infrared stabilizers, plasticizers, leveling agents, surfactants, coupling agents and fillers.

23. A thermosetting one solution-type composition for a protective film for a color filter, comprising:
(i) a self-curable copolymer comprising
a) a repeating unit of Formula I in an amount in a range of about 5 to about 45 mol %, wherein R₁ is hydrogen or alkyl; and 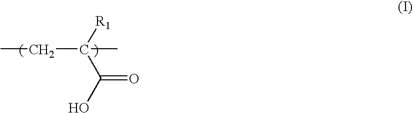
b) one or more of the repeating units of Formulae II, III and IV, wherein each of the repeating units of Formula II, III and IV, if present, is present in an amount in a range of about 20 to about 85 mol %, wherein R₂, R₃ and R₄ are each independently hydrogen or alkyl, and p is a positive integer; 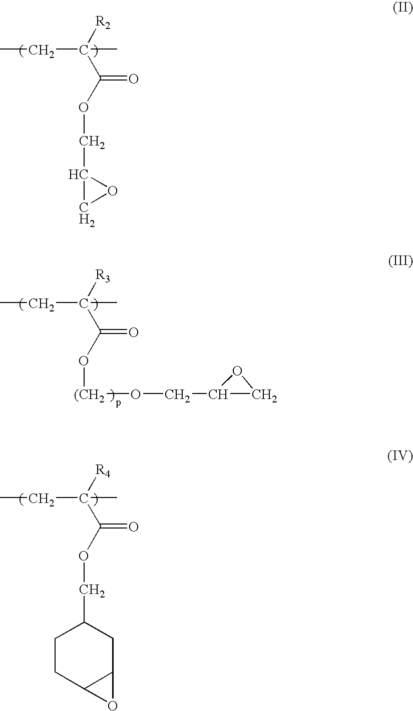
(c) a repeating unit of Formula V in an amount in a range of about 10 to about 30 mol %, wherein R₅ is hydrogen or alkyl, and R₆ is selected from the group consisting of cycloalkyl, adamantyl, norbornyl and tetrahydrocyclopentadienyl; and 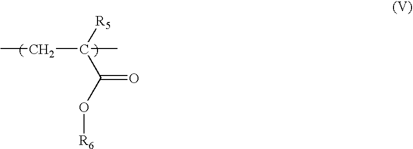
(d) one or more repeating units selected from the group consisting of acrylates, methacrylates, acrylamides, styrenes, N-vinylpyrrolidone, N-vinylformamide; N-vinylamide, and N-vinylimidazole; and
(ii) an organic solvent.

24. The composition of claim 23, wherein R₁, R₂, R₃, R₄ and R₅ are each independently hydrogen or C₁-C₃ alkyl, and p is a positive integer between 1 and 9.

25. The composition of claim 23, wherein R₆ is selected from the group consisting of C₅-C₁₃ cycloalkyl, 1,7,7-trimethyl-2-norbornyl, 1,7,7-trimethyl-3-norbornyl 2-adamantyl, 2-alkyl-2-adamantyl and tetrahydrocyclopentadienyl.

26. The composition of claim 23, wherein the repeating units of Formulae II, III and IV are, in total, present in an amount in a range of about 20 to about 85 mol %.

27. The composition of claim 23, wherein the self-curable copolymer has a weight average molecular weight in a range of about 3,000 to about 1,000,000 g/mol.

28. The composition of claim 23, wherein the organic solvent is selected from the group consisting of ethylene glycols, glycol ethers, glycol ether acetates, propylene glycol ethers, propylene glycol ether acetates, amides, ketones, petroleum solvents, esters and any mixture thereof.

29. The composition of claim 23, further comprising at least one resin selected from the group consisting of epoxy-based resins, polyacrylate-based resins, polymethacrylate-based resins, polyamide resins, polyester resins, polyimide resins and silicone-based resins.

30. The composition of claim 23, further comprising at least one additive selected from the group consisting of antioxidants, infrared stabilizers, plasticizers, leveling agents, surfactants, coupling agents and fillers.

31. A color filter comprising a protective film formed from the composition of claim 1.

32. The color filter of claim 31, wherein the protective film has a thickness in a range of about 0.5 to about 5 μm.

33. A liquid crystal display comprising the color filter of claim 31.

34. A color filter comprising a protective film formed from the composition of claim 8.

35. The color filter of claim 34, wherein the protective film has a thickness in a range of about 0.5 to about 5 μm.

36. A liquid crystal display comprising the color filter of claim 34.

37. A color filter comprising a protective film formed from the composition of claim 15.

38. The color filter of claim 37, wherein the protective film has a thickness in a range of about 0.5 to about 5 μm.

39. A liquid crystal display comprising the color filter of claim 37.

40. A color filter comprising a protective film formed from the composition of claim 23.

41. The color filter of claim 40, wherein the protective film has a thickness in a range of about 0.5 to about 5 μm.

42. A liquid crystal display comprising the color filter of claim 40.
